(19) United States
(12) Patent Application Publication
(10) Pub. No.: US 2020/0026998 A1
(43) Pub. Date: Jan. 23, 2020

(54) INFORMATION PROCESSING APPARATUS FOR CONVOLUTION OPERATIONS IN LAYERS OF CONVOLUTIONAL NEURAL NETWORK

(71) Applicant: Toshiba Memory Corporation, Minato-ku (JP)

(72) Inventors: Asuka MAKI, Kawasaki (JP); Daisuke Miyashita, Kawasaki (JP); Kengo Nakata, Tokyo (JP); Fumihiko Tachibana, Yokohama (JP); Jun Deguchi, Kawasaki (JP); Shinichi Sasaki, Tokyo (JP)

(73) Assignee: Toshiba Memory Corporation, Minato-ku (JP)

(21) Appl. No.: 16/291,471

(22) Filed: Mar. 4, 2019

(30) Foreign Application Priority Data
Jul. 20, 2018 (JP) 2018-136714

(51) Int. Cl. G06N 3/08; G06F 7/544; G06N 3/04; G06N 3/06

(52) U.S. Cl. CPC G06N 3/08; G06N 3/06; G06N 3/04; G06F 7/5443

(57) ABSTRACT

According to one embodiment, an information processing apparatus for convolution operations in layers of a convolutional neural network, includes a memory and a product-sum operating circuitry. The memory is configured to store items of information indicative of an input, a weight to the input, and a bit width determined for each filter of the weight. The product-sum operating circuitry is configured to perform a product-sum operation based on the items of information indicative of the input, the weight, and the bit width, stored in the memory.

### CROSS-REFERENCE TO RELATED APPLICATIONS

This application is based upon and claims the benefit of priority from Japanese Patent Application No. 2018-136714, filed Jul. 20, 2018, the entire contents of which are incorporated herein by reference.

### FIELD

Embodiments described herein relate generally to an information processing apparatus for convolution operations in layers of a convolutional neural network.

### BACKGROUND

In layers of a convolutional neural network (CNN) for use in image recognition processing, etc., convolution operations are performed.

Such convolution operations in layers of CNN involve a great deal of calculations. Accordingly, bit precision is often differentiated on an operation-by-operation basis with the aim of mitigating calculation load and improving efficiency.

Also, a CNN includes multiple layers. It is known that the bit precision required for realizing recognition accuracy necessary in, for example, image recognition processing varies depending on each of the layers.

### BRIEF DESCRIPTION OF THE DRAWINGS

FIG. 1 is a diagram showing an information processing apparatus according to a first embodiment.

FIG. 2 is a block diagram for explaining exemplary processing for calculating a bit width Bwₘ.

FIG. 3 is a diagram showing an example of a weight W_{n,ky,kx} among plural weights w_{m,n,ky, kx}.

FIG. 4 is a diagram showing an information processing apparatus according to a second embodiment.

FIG. 5 is a diagram showing an information processing apparatus according to a third embodiment.

FIG. 6 is a block diagram for explaining exemplary processing for calculating a weight w′, a bit width Bwₘ, and a correction value bw′ₘ.

FIG. 7 is a diagram showing an information processing apparatus according to a fourth embodiment.

FIG. 8 is a diagram showing an information processing apparatus according to a fifth embodiment.

FIG. 9 is a diagram showing first exemplary product-sum operation circuitry.

FIG. 10A is a diagram showing how values of input data W and X are each input to an operator array.

FIG. 10B is another diagram showing how the values of the input data W and X are each input to the operator array.

FIG. 11 is a diagram showing a configuration of an LUT.

FIG. 12 is a flowchart for explaining a post-processing operation for second exemplary product-sum operation circuitry.

FIG. 13 is a diagram for explaining a three-dimensional structure of an input x for a convolution operation performed in a CNN layer.

FIG. 14 is a diagram for explaining a four-dimensional structure of a weight w.

FIG. 15 is a diagram for explaining a product-sum operation.

### DETAILED DESCRIPTION

According to one embodiment, an information processing apparatus for convolution operations in layers of a convolutional neural network, includes a memory and a product-sum operating circuitry. The memory is configured to store items of information indicative of an input, a weight to the input, and a bit width determined for each filter of the weight. The product-sum operating circuitry is configured to perform a product-sum operation based on the items of information indicative of the input, the weight, and the bit width, stored in the memory.

Embodiments will be described with reference to the drawings.

### [Overview of CNN]

A CNN is formed of multiple layers. Principal processing in each layer is given as following expression (1).

$${y}_{m , r , c} = {\sum }_{n = 0}^{{N}_{- 1}} {\sum }_{ky = 0}^{{Ky}_{- 1}} {\sum }_{kx = 0}^{{Kx}_{- 1}} {w}_{m , n , ky , kx} \times {x}_{n , r + ky , c + {kz}^{1}} 0 \leq m < {M}_{1} 0 \leq r < {R}_{1} 0 \leq c < C \qquad ( 1 )$$

In the expression, y_{m,r,c} is referred to as an output, X_{n,r,c} is referred to as an input, and w_{m,n,ky,kx} is referred to as a weight. Each value of weight is determined in advance through learning processes, so the values are already known and fixed values when processing such as image recognition is performed. On the other hand, for the case of image recognition, the input x_{n,r,c} and the output y_{m,r,c} are changed as an input image changes.

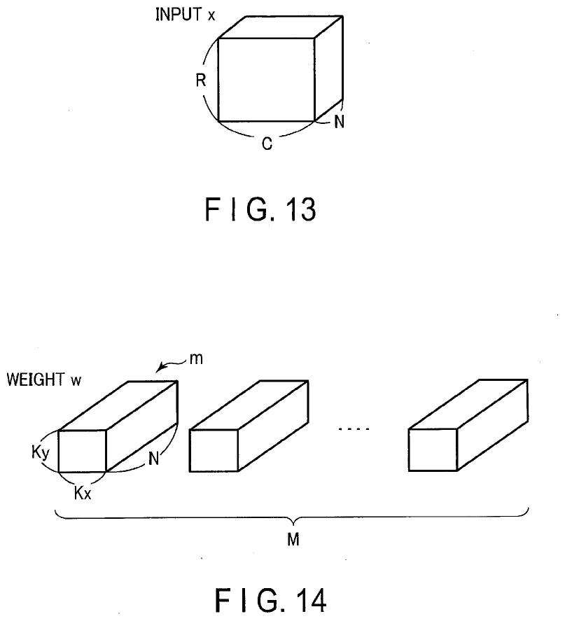

The input x takes a three-dimensional structure having a height R, a width C, and a channel N, and may be expressed as an N×R×C cuboid as shown in FIG. 13. The channel N corresponds to, for example, one of colors R, G, and B in terms of images. The weight w includes M filters m. The weight w takes a four-dimensional structure having a height Ky, a width Kx, an input channel N, and an output channel M (or filter m). A three dimensions of the weight w, namely, the height Ky, the width Kx, and the input channel N, correspond to the structure of the input x, and may be expressed as a cuboid in a similar manner to the input x. Generally, the value Ky is smaller than the value R, and the value Kx is smaller than the value C. Since there is one more dimension, namely, the filter m, the pictorial representation of the weight w may be M cuboids having the dimensions N×Ky×Kx, as shown in FIG. 14.

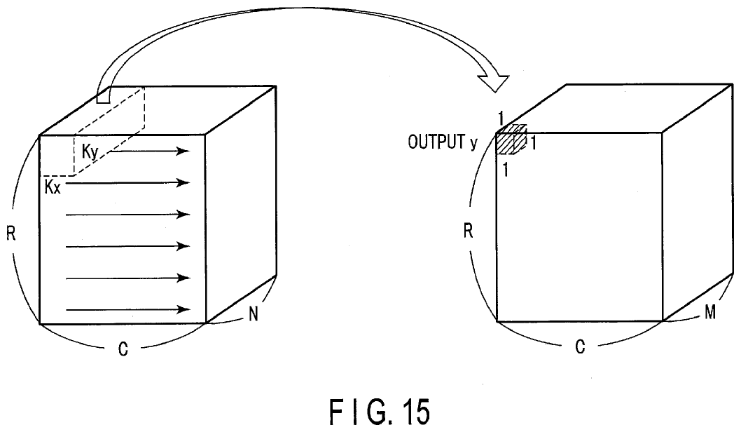

Note that cutting out a region of the size equal to one filter m of the weight w from the input x cuboid, and performing a product-sum operation, i.e., multiplying the values and summing all the multiplication results within the region, will yield a single value in the output y (see FIG. 15). Since R×C×M values can be calculated from the combinations of segments of the input x (which part of the input x should be cut out) and the filter m (which filter m of the weight w should be used), the output y will take a structure of a three-dimensional cuboid as the input x.

For performing the foregoing processing, it is common to use the same format, e.g., the same single-precision floating point, for all of the output y, the input x, and the weight w. That is, use of the same bit precision for all of the output y, the input x, and the weight w is general.

### First Embodiment

This embodiment is based particularly on the nature of CNN processing, where a product-sum operation is performed for each filter m as discussed above.

For the sake of simplicity, the description will assume an instance of the weight w being expressed by integers. For example, the weight w of a given layer includes M×N×Ky×Kx values, and it is supposed that the largest value among them is 100, and the smallest value is −100. In this case, 8-bit precision would be typically used as the bit precision for the weight win order to express the largest value and the smallest value, since 8 bits can express a value from −128 to +127.

In the first embodiment, a bit width of the weight w is determined for each value of the weight w for a filter m. The weight w includes M filters m. The maximum weight value for one of these filters m is 100, and the minimum weight value for one of these filters m is −100. However, it will be supposed that, for the 0th filter m, for example, the weight value may take 50 as the maximum value and −10 as the minimum value. In this case, 7 bits are sufficient and 8 bits are not necessary for the 0th filter m, since 7 bits can express a value from −64 to +63. Similarly, the maximum weight value and the minimum weight value are estimated for each filter m, and the smallest bit width required is used. In this way, the entire calculation amount, and the capacity of a memory necessary for weight storage may be reduced.

Besides, a product-sum operation is performed for each filter m as discussed above. Since all the product-sum operations for N×Ky×Kx, performed as many as the M filters for calculating one given output y, can use the same bit width for the filter m, efficient processing is possible.

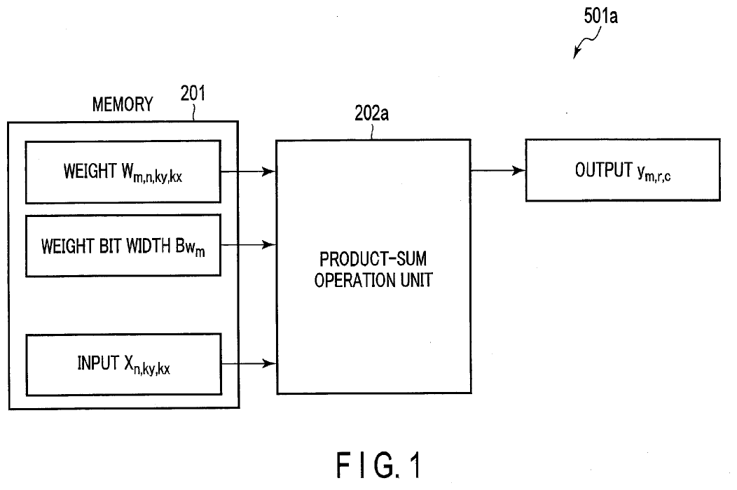

FIG. 1 is a diagram showing an information processing apparatus 501a according to the first embodiment.

As shown in FIG. 1, the information processing apparatus 501a according to the first embodiment includes a memory 201 adapted to store information for a weight w_{m,n,ky,kx}, information for a bit width Bwₘ of the weight w_{m,n,ky,kx}, and information for an input x_{n,ky,kx}. The bit width Bwₘ of the weight w is determined with respect to each filter m.

These information items for the weight w_{m,n,ky,kx}, the bit width Bwₘ of the weight w_{m,n,ky,kx}, and the input x_{n,ky,kx}, stored in the memory 201, are input to a product-sum operation unit 202a. Note that the information items for the weight w_{m,n,ky,kx}, the bit width Bwₘ of the weight w_{m,n,ky, kx}, and the input x_{n,ky,kx} may be directly input to the product-sum operation unit 202a without being stored in the memory 201.

The product-sum operation unit 202a performs processing for product-sum operations based on the information items for the weight w_{m,n,ky,kx}, the bit width Bwₘ of the weight w_{m,n,ky,kx}, and the input x_{n,ky,kx}, stored in the memory 201.

The product-sum operation unit 202a performs processing for product-sum operations in accordance with, and appropriate for, the information for the bit width Bwₘ. The processing for product-sum operations by the product-sum operation unit 202a may be software processing for implementation by a processor, or hardware processing for implementation by product-sum operation circuitry. The product-sum operation circuitry may be, for example, logical operation circuitry.

The output from the product-sum operation unit 202a is given as y_{m,r,c} as indicated by the expression (1).

The weight w_{m,n,ky,kx}, and the bit width Bwₘ of the weight w_{m,n,ky,kx} with respect to each filter m are values which have been calculated through learning processes, and stored in the memory 201.

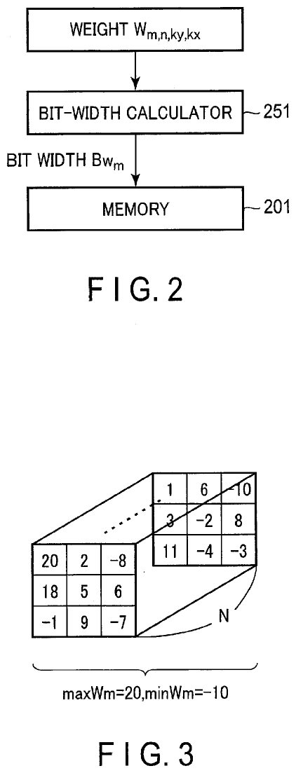

The bit width Bwₘ may also be obtained through calculation by a bit-width calculator (processor) 251. As shown in FIG. 2, the bit width Bwₘ with respect to each filter m is calculated from the weight w_{m,n,ky,kx} for each filter m, and the calculated bit width Bwₘ is input to the memory 201.

The following method may be adopted for calculating the bit width Bwₘ with respect to each filter m.

FIG. 3 shows an example of a weight w_{n,ky,kx} among the weight w_{m,n,ky,kx}. M sets of such a portion constitute the weight w_{m,n,ky,kx}, as shown in FIG. 14. The weight w_{n,ky,kx} has many values, including 20 as the maximum value and −10 as the minimum value in the example shown in FIG. 3.

The bit width Bwₘ of the weight w_{m,n,ky,kx} is calculated by a processor (not shown). The bit width Bwₘ adopts the number that is obtained by adding one bit to a bit width which is a binarized expression of the maximum value (maximum absolute value) of the weight w_{m,n,ky,kx}. The addition of one bit is involved since it is necessary to utilize the maximum value in the positive domain or the negative domain with respect to the center 0, for expressing the other domain as well.

For the example shown in FIG. 3, the calculation is as follows.

$$\begin{matrix}Bit width {Bw}_{m} = ⌈ {log}_{2} 20 ⌉ + 1 \\ = ⌈ 4.3 ⌉ + 1 \\ = 6\end{matrix}$$

The symbol “┌ ┐” indicates a ceiling function.

Accordingly, the required bit width Bwₘ is found to be 6 bits.

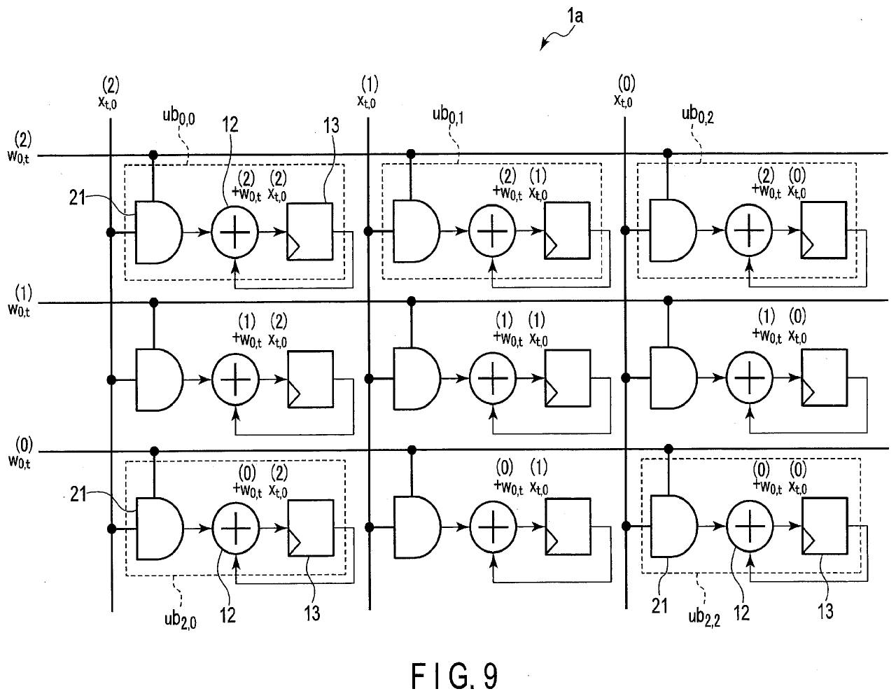

As the product-sum operation unit 202a, it is possible to adopt, for example, product-sum operation circuitry configured to receive input of multibit data as shown in FIG. 9 (discussed in more detail later). FIG. 9 shows the case where the input x_{n,ky,kx} and the bit width Bwₘ of the weight w_{m,n,ky,kx} are each three bits. Note that ky and kx in the input x_{n,ky,kx} and the weight w_{m,n,ky,kx} are given by time t. Also, FIG. 9 shows the input x_{t,0} and the weight w_{0,t} when filter m=0.

### Second Embodiment

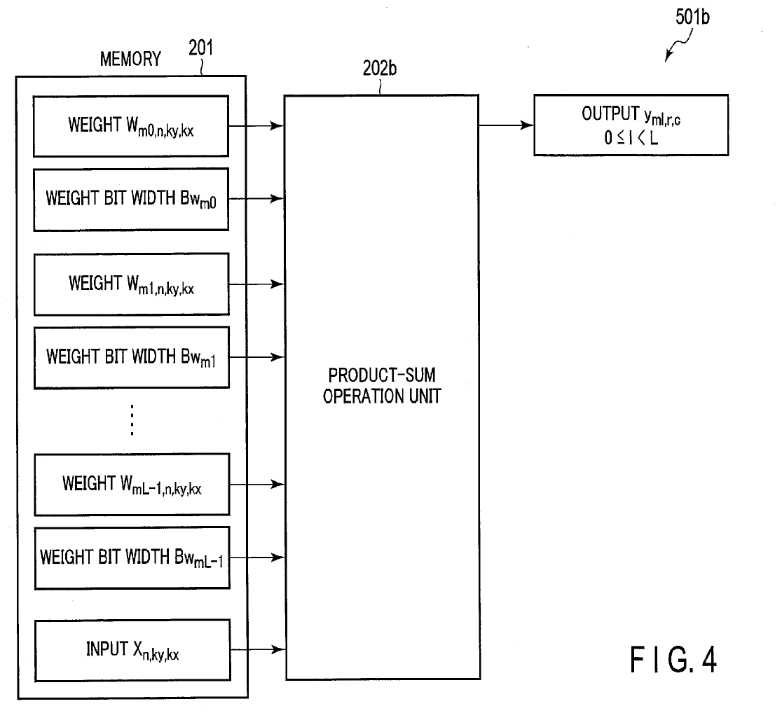

FIG. 4 is a diagram showing an information processing apparatus 501b according to the second embodiment. The information processing apparatus 501b according to the second embodiment includes a product-sum operation unit 202b capable of simultaneous, parallel processing for multiple filters m.

In the second embodiment as shown in FIG. 4, the memory 201 stores information for weights wₘ₀ to w_{mL-1} for L filters m, information for bit widths Bwₘ₀ to Bw_{mL-1} of the weights wₘ₀ to w_{mL-1}, and information for an input X_{n,ky,kx}.

According to the second embodiment, the bit widths Bwₘ₀ to Bw_{mL-1} of the weights wₘ₀ to w_{mL-1} are different for the respective L filters m. The weights wₘ₀ to w_{mL-1} for the L filters m, and the bit widths Bwₘ₀ to Bw_{mL-1} of the respective weights wₘ₀ to w_{mL-1} are input to the product-sum operation unit 202b. Note that the weights wₘ₀ to w_{mL-1} for the L filters m, the bit widths Bwₘ₀ to Bw_{mL-1} of the weights wₘ₀ to w_{mL-1}, and the input x_{n,ky,kx} may be directly input to the product-sum operation unit 202b without being stored in the memory 201.

The product-sum operation unit 202b performs processing for product-sum operations for a group of multiple filters m, based on the information items for the weights wₘ₀ to w_{mL-1} for the L filters m, the bit widths Bwₘ₀ to Bw_{mL-1} of the respective weights wₘ₀ to w_{mL-1}, and the input x_{n,ky,kx}, stored in the memory 201.

In the product-sum operation unit 202b, processing for multiple filters m is performed in a parallel manner. The product-sum operation unit 202b performs processing for product-sum operations in accordance with, and appropriate for, the input bit widths Bwₘ₀ to Bw_{mL-1} of the respective weights wₘ₀ to w_{mL-1} for the filter m. The processing for product-sum operations by the product-sum operation unit 202b may be software processing for implementation by a processor, or hardware processing for implementation by product-sum logical operation circuitry. The output from the product-sum operation unit 202b is given as y_{m,r,c} as indicated by the expression (1)

As the product-sum operation unit 202b, it is possible to adopt, for example, product-sum operation circuitry configured to receive input of multibit data as shown in FIG. 9 (discussed in more detail later). Moreover, it is possible to adopt product-sum operation circuitry configured for simultaneous, parallel processing for multiple filters m.

### Third Embodiment

It has been supposed in the first embodiment that the weight value for the 0th filter m takes the maximum value of 50 and the minimum value of −10, and 7 bits are necessarily used in order to express this range in the normal two's complement representation. However, the range of +50 to −10 covers at the most 61 kinds of integers, which fall within the range that can be expressed with 6 bits. The third embodiment estimates the range of filter in and uses the minimum bit width required, instead of using the maximum weight value and the minimum weight value for each filter m. This allows for reduction of the entire calculation amount and the capacity of a memory that must be secured for storing the weights.

The processing according to this embodiment may be given as the following expression.

$${y}_{m , r , c} = {\sum }_{n = 0}^{{N}_{- 1}} {\sum }_{ky = 0}^{{Ky}_{- 1}} {\sum }_{kx = 0}^{{Kz}_{- 1}} ( {w}_{m , n , ky , kz}^{′} + {b}_{m} ) \times {x}_{n , r + ky , c + kx} = {\sum }_{n = 0}^{{N}_{- 1}} {\sum }_{ky = 0}^{{Ky}_{- 1}} {\sum }_{kx = 0}^{{Kx}_{- 1}} {w}_{m , n , ky , kx}^{′} \times {x}_{n , r + ky , c + kz} + {b}_{m} \times {\sum }_{n = 0}^{{N}_{- 1}} {\sum }_{ky = 0}^{{Ky}_{- 1}} {\sum }_{kx = 0}^{{Kz}_{- 1}} {x}_{n , r + ky , c + kx} \qquad ( 2 )$$

Here, w_{m,n,ky,kx}=w′_{m,n,ky,kx}+bₘ. Note that bₘ is a value for correcting w′ so that the range of w can be expressed in the minimum bit precision required, and bₘ takes a single value for each filter m. For example, bₘ can be defined as bₘ=(max w+1+min w)/2. This renders the bit width. Bw′ₘ of the weight w′ₘ smaller than the bit width Bwₘ of the original weight wₘ, and therefore, the first term in the expression (2) can be calculated with a smaller bit width. The expression (2) additionally includes the second term as compared to the expression (1). Nevertheless, while the first term requires M+N+Ky+Kx+R+C product-sum operations, the second term can be calculated by N×R×C+Ky×Kx×R×C additions. Since the second term is sufficiently smaller than the first term, it can be expected that having the smaller bit width for the first term would provide an effect beyond the overhead introduced by the addition of the processing of the second term.

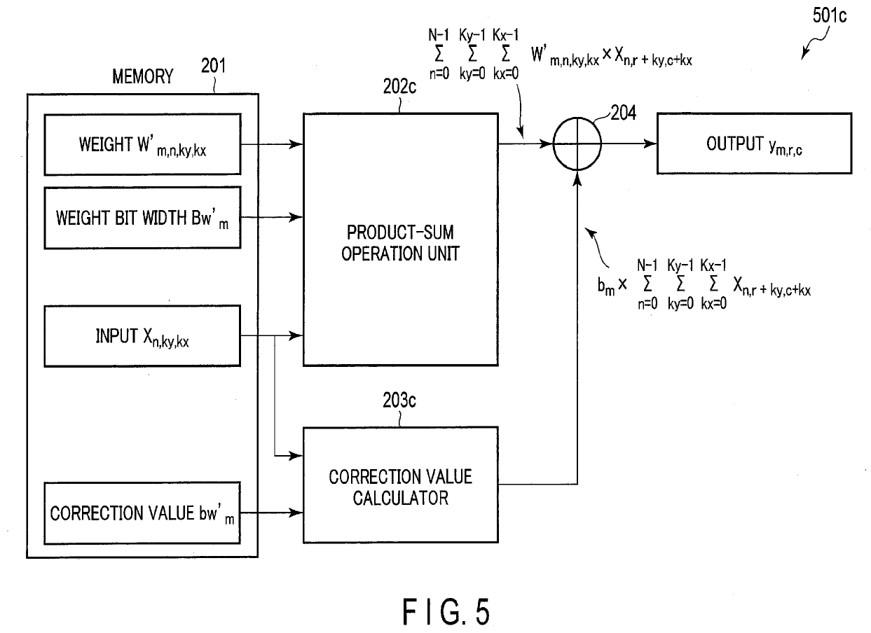

FIG. 5 is a diagram showing an information processing apparatus 501c according to the third embodiment.

As shown in FIG. 5, the information processing apparatus 501c according to the third embodiment includes, in addition to the configurations of the first embodiment, a correction value calculator 203c for calculating the second term in the expression (2) based on information for the input x and a correction value bw′ₘ.

The memory 201 stores information for the weight w′_{m,n,ky,kx}, information for the bit width Bw′ₘ of the weight w′_{m,n,ky,kx}, information for the input x_{n,ky,kx}, and information for the correction value bw′ₘ. The bit width Bw′ₘ of the weight w′ is determined with respect to each filter m.

The information items for the weight w′_{m,n,ky,kx}, the bit width Bw′ₘ of the weight w′_{m,n,ky,kx}, and the input x_{n,ky,kx}, stored in the memory 201, are input to a product-sum operation unit 202c. Note that these information items for the weight w′_{m,n,ky,kx}, the bit width Bw′ₘ of the weight w′_{m,n,ky,kx}, and the input x_{n,ky,kx} may be directly input to the product-sum operation unit 202c without being stored in the memory 201.

The product-sum operation unit 202c performs processing for product-sum operations in accordance with, and appropriate for, the information for the bit width Bw′ₘ.

The output from the product-sum operation unit 202c is expressed as the first term in the expression (2).

The input x_{n,ky,kx} and the correction value bw′ₘ, stored in the memory 201, are input to the correction value calculator 203c. The correction value calculator 203c outputs a correction value expressed as the second term in the expression (2), based on the input x_{m,ky,kx}, and the correction value bw′ₘ from the memory 201.

An adder 204 adds together the output from the product-sum operation unit 202c (the first term in the expression (2)) and the output from the correction value calculator 203c (the second term in the expression (2)) to output y_{m,r,c}.

The processing for product-sum operations by the product-sum operation unit 202c, the processing for correction value calculation by the correction value calculator 203c, and the processing for addition by the adder 204 may be software processing for implementation by a processor, or hardware processing for implementation by product-sum logical operation circuitry.

As in the preceding embodiments, the bit width Bw′ₘ of the weight w′ differs for each filter m. The correction value bw′ₘ also differs for each filter m.

The product-sum operation unit 202c performs processing for product-sum operations in accordance with, and appropriate for, the information for the bit width Bw′ₘ.

As the product-sum operation unit 202c, it is possible to adopt, for example, product-sum operation circuitry configured to receive input of multibit data as shown in FIG. 9 (discussed in more detail later). Moreover, it is possible to adopt product-sum operation circuitry configured for simultaneous, parallel processing for multiple filters m.

The output from the adder 204 is given as y_{m,r,c} as indicated by the expression (1).

The weight w′_{m,n,ky,kx}, the bit width Bw′ₘ of the weight w′_{m,n,ky,kx} with respect to each filter m, and the correction value bw′ₘ are values which have been calculated through learning processes, and stored in the memory 201.

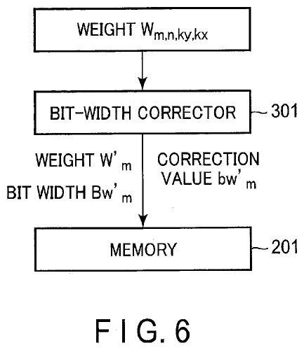

The weight w′, the bit width Bw′ₘ of the weight w′, and the correction value bw′ₘ may also be obtained through calculation by a bit-width corrector (processor) 301. As shown in FIG. 6, the bit-width corrector 301 calculates the weight w′ₘ, the bit width Bw′ₘ, and the correction value bw′ₘ, from the weight w_{m,n,ky,kx} to the input x_{n,ky,kx} before storage in the memory 201. The bit width Bw′ₘ is calculated for each filter m. These information items for the weight w′ₘ, the bit width Bw′ₘ, and the correction value bw′ₘ, obtained from the weight w_{m,n,ky,kx}, are input to the memory 201.

According to the third embodiment, the correction value bw′m is used so that the bit width of the weight is optimized into a smaller value. The weight w′_{m,n,ky,kx}, the bit width Bw′ₘ, and the input x are input to the product-sum operation unit 202c, and the correction value bw′ₘ for use in correction is input to the correction value calculator 203c.

The weight w′_{m,n,ky,kx}, the bit width Bw′ₘ, and the correction value bw′ₘ are calculated by the bit-width corrector 301 in the following manner.

In the example shown in FIG. 3, a bit width of 6 bits is required for the weight w_{m,n,ky,kx}.

In practice, however, it is sufficient if 31 values (20+10+1) are expressed. Therefore, the required minimum bit width of the weight is given as follows, where it is determined to be 5.

Bit width Bw′ₘ=┌ log₂31 ┐=┌4.9┐=5

In this example, subtracting “5” from every value renders the maximum value 15 and the minimum value −15, and accordingly, 5 bits can express this range. As such, the correction value bw′ₘ is “5”. This value “5” may be calculated as, for example, (max wₘ+1+min wₘ)/2.

With the information processing apparatus 501c according to the third embodiment, the product-sum operation unit 202c that involves a great deal of calculations can use the bit width of the weight, which has been reduced from 6 bits to 5 bits, and therefore, the resulting calculation amount can further be reduced.

### Fourth Embodiment

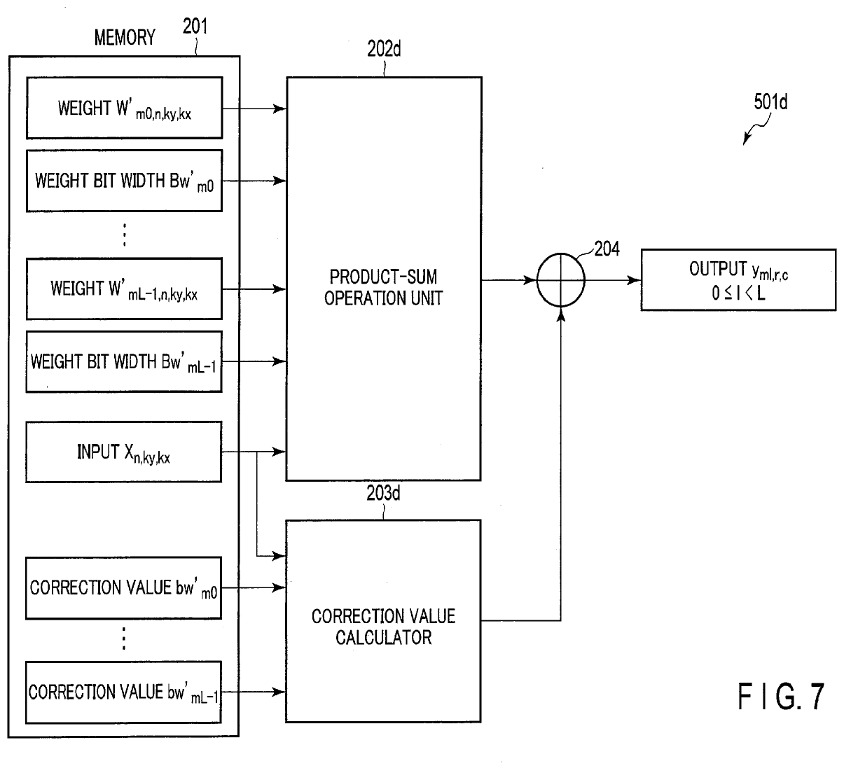

FIG. 7 is a diagram showing an information processing apparatus 501d according to the fourth embodiment. The information processing apparatus 501d according to the fourth embodiment includes a product-sum operation unit 202d capable of simultaneous, parallel processing for multiple filters m.

In the fourth embodiment as shown in FIG. 7, the memory 201 stores information for weights w′ₘ₀ to w′_{mL-1} for L filters m, information for bit widths Bw′ₘ₀ to Bw′_{mL-1} of the weights w′ₘ₀ to W′_{mL-1}, information for an input x_{n,ky,kx}, and information for correction values bw′ₘ₀ to bw′_{mL-1}.

According to the fourth embodiment, the bit widths Bw′ₘ₀ to Bw′_{mL-1} are different for the respective L filters m. The information items for the weights w′ₘ₀ to w′_{mL-1} for L filters m, the bit widths Bw′ₘ₀ to Bw′_{mL-1} of the respective weights w′ₘ₀ to w′_{mL-1}, and the input x_{n,ky,kx} are input to the product-sum operation unit 202d. Note that these information items for the weights w′ₘ₀ to w′_{ML-1} for L filters m, the bit widths Bwₘ₀ to BW′_{mL-1} of the weights w′ₘ₀ to w′_{mL-1}, and the input x_{n,ky,kx} may be directly input to the product-sum operation unit 202d without being stored in the memory 201.

The product-sum operation unit 202d performs processing for product-sum operations based on the information items for the weights w′ₘ₀ to w′_{mL-1} for L filters m, the bit widths Bw′ₘ₀ to Bw′_{mL-1} of the respective weights w′ₘ₀ to w′_{mL-1}, and the input X_{n,ky,kx}, stored in the memory 201.

In the product-sum operation unit 202d, processing for multiple filters m is performed in a parallel manner. The product-sum operation unit 202d performs processing for product-sum operations in accordance with, and appropriate for, the input bit widths Bw′ₘ₀ to BW′_{mL-1} of the respective weights w′ₘ₀ to w′_{mL-1} for the filter m. The output from the product-sum operation unit 202d is expressed as the first term in the expression (2)

As the product-sum operation unit 202d, it is possible to adopt, for example, product-sum operation circuitry configured to receive input of multibit data as shown in FIG. 9 (discussed in more detail later). Moreover, it is possible to adopt product-sum operation circuitry configured for simultaneous, parallel processing for multiple filters m.

A correction value calculator 203d outputs a correction value expressed as the second term in the expression (2), based on the input x_{n,ky,kx} and the correction values bw′ₘ₀ to bw′_{mL-1} input from the memory 201.

The adder 204 adds together the output from the product-sum operation unit 202d (the first term in the expression (2)) and the output from the correction value calculator 203d (the second term in the expression (2)) to output y_{m,r,c}.

The processing for product-sum operations by the product-sum operation unit 202d, the processing for correction value calculation by the correction value calculator 203d, and the processing for addition by the adder 204 may be software processing for implementation by a processor, or hardware processing for implementation by product-sum logical operation circuitry.

The output from the adder 204 is given as y_{m,r,c} as indicated by the expression (1).

### Fifth Embodiment

As discussed for the first to fourth embodiments, the product-sum operation units 202a to 202d each receive data input of the bit width Bwₘ or Bw′ₘ, which is different for each filter m. In the description of the fifth embodiment, a series of data processing for the data x and w, input from the memory to the product-sum operation circuitry and differing in bit width Bw for each filter m, will be explained.

### [Configuration of Information Processing Apparatus]

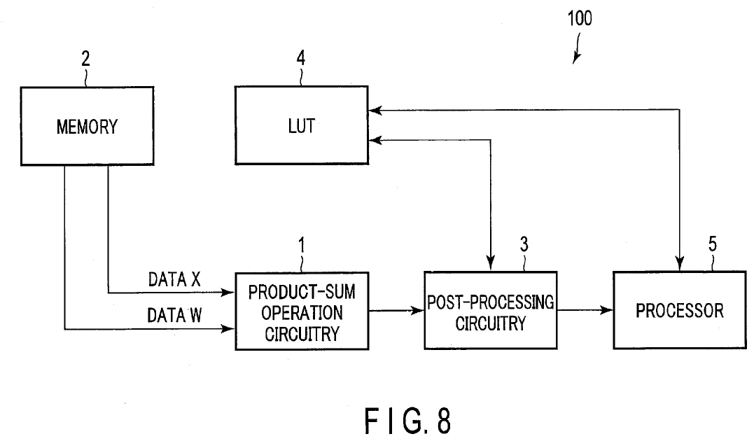

FIG. 8 is a diagram showing an information processing apparatus 100 according to the fifth embodiment.

As shown in FIG. 8, the information processing apparatus 100 includes product-sum operation circuitry 1 to which the memory 2 and post-processing circuitry 3 are coupled. Two data items (data X and W) stored in the memory 2 are input to the product-sum operation circuitry 1.

The data X is expressed in a matrix form with t rows and r columns, and the data W is expressed in a matrix form with m rows and t columns (t, r, and m each being 0 or a positive integer). The embodiment will assume t to be time (read cycle).

The two matrices will be given as:

W={w_{m,t}}0≤m≤M−1, 0≤t≤T−1, and

X={x_{t,r}}0≤t≤T−1, 0≤r≤R−1,

in which T−1 is the maximum value of read cycles, R−1 is the maximum column number of the matrix data X, and M−1 is the maximum row number of the matrix data W.

The product-sum operation circuitry 1 performs a matrix operation using the two data items (W, X) input from the memory 2, and outputs the operation result to the post-processing circuitry 3. More specifically, the product-sum operation circuitry 1 includes a plurality of processing elements arranged in an array and each including a multiplier and an accumulator.

Assuming that a matrix to be calculated is Y=WX, the operation for each element of Y={y_{m,r}}0≤m≤M−1, 0≤r≤R−1 takes a product-sum form as follows.

$${y}_{m , r} = {\sum }_{t = 0}^{T - 1} {w}_{m , t} \times {x}_{t , r} \qquad ( 3 )$$

The product-sum operation circuitry 1 accordingly outputs the result of the product-sum operation to the post-processing circuitry 3.

The memory 2 may have any configuration as long as it is a semiconductor memory, such as an SRAM, a DRAM, an SDRAM, a NAND flash memory, a three-dimensionally designed flash memory, an MRAM, a register, a latch circuit, or the like.

The post-processing circuitry 3 performs an operation to the output from the product-sum operation circuitry 1, which includes the output of each arithmetic operator at time T−1 corresponding to an m-th row and an r-th column, using a predetermined coefficient settable for each processing element. The post-processing circuitry 3 then puts an output index to the operation result and outputs it to a processor 5. In these actions, the post-processing circuitry 3 acquires the predetermined coefficient and the output index from a lookup table (LUT) 4 as necessary.

If the post-processing is not required, the post-processing circuitry 3 maybe omitted, and the output from the product-sum operation circuitry 1 may be supplied to the processor 5.

The LUT 4 stores the predetermined coefficients and the output indexes for the respective processing elements in the product-sum operation circuitry 1. The LUT 4 may be storage circuitry.

The processor 5 receives results of the product-sum operations of the respective processing elements after the processing by the post-processing circuitry 3. The processor 5 is capable of setting the predetermined coefficients and the output indexes to be stored in the LUT 4 and set for the respective processing elements.

[First Exemplary Product-Sum Operation Circuitry (Multibit Case 1: Product-Sum Operation Circuitry When Input Data w_{m,t} and x_{t,r} are 3 Bits)]

FIG. 9 shows first exemplary product-sum operation circuitry 1a for the information processing apparatus 100 according to the fifth embodiment. It embraces the case where each of the input data w_{0,t} and x_{t,0} is 3-bit data.

For example, assuming that the product-sum operation unit 202a according to the first embodiment is applied, the product-sum operation circuitry 1a of FIG. 9 corresponds to the case where the bit width Bwₘ of the weight w, input to the product-sum operation unit 202a, is 3 bits, and the filter m is 0. Also, the indices n, ky, and kx are collectively handled as t (time). For example, it is possible to give t=(n×Ky+ky)×Kx+kx.

FIG. 9 shows that 9 processing elements ub_{0,0} to ub_{2,2} are arrayed in parallel. An “processing element ub_{m,r}” refers to the processing element positioned at the m-th row and the r-th column. The processing elements ub_{0,0} to ub_{2,2} each include a multiplier 21, an adder 12, and a register 13.

The multiplier 21 in each of the processing elements ub_{0,0} to ub_{2,2} includes a first input terminal and a second input terminal. The first input terminal of the multiplier 21 in an processing element ub_{m,r} is coupled to a data line that is common to the other processing elements arranged on the m-th row, and the second input terminal is coupled to a data line that is common to the other processing elements arranged on the r-th column.

In other words, first inputs which are supplied to the first input terminals of certain multipliers 21 (among all the processing elements ub_{m,r}) share the data line for data w_{m,t} in the row direction, and second inputs which are supplied to the second input terminals of certain multipliers 21 share the data line for data x_{t,r} in the column direction.

As such, at time t, the first inputs to the multipliers 21 in the processing elements ub_{0,0}, ub_{0,1}, and ub_{0,2} share the value of data w⁽²⁾_{0,t}, the first inputs to the multipliers 21 in the processing elements ub_{1,0}, ub_{1,1}, and ub_{1,2} share the value of data w⁽¹⁾_{0,t}, and the first inputs to the multipliers 21 in the processing elements ub_{2,0}, ub_{2,1}, and ub_{2,2} share the value of data w⁽⁰⁾_{0,t}.

Similarly, at the time t, the second inputs to the multipliers 21 in the processing elements ub_{0,0}, ub_{1,1}, and ub_{2,0} share the value of data x⁽²⁾_{t,0}, the second inputs to the multipliers 21 in the processing elements ub_{0,1}, ub_{1,1}, and ub_{2,1} share the value of data x⁽¹⁾_{t,0}, and the second inputs to the multipliers 21 in the processing elements ub_{0,2}, ub_{1,2}, and ub_{2,2} share the value of data x⁽⁰⁾_{t,0}.

The multiplier 21 in each of the processing elements ub_{0,0} to ub_{2,2} multiplies data of the first input by data of the second input, and outputs the multiplication result to the adder 12.

Accordingly, the multipliers 21 in the processing elements ub_{0,0}, ub_{0,1}, and ub_{0,2} at the time t output the respective multiplication results (i.e. the results of multiplying the data w⁽²⁾_{0,t} of the first input by the data x⁽²⁾_{t,0}, x⁽¹⁾_{t,0}, and x⁽⁰⁾_{t,0} of the second input, respectively).

Also, the multipliers 21 in the processing elements ub_{0,0}, ub_{1,0}, and ub_{2,0} at the time t output the respective multiplication results (i.e. the results of multiplying the data x⁽²⁾_{t,0} of the second input by the data w⁽²⁾_{0,t}, w⁽¹⁾_{0,t}, and w⁽⁰⁾_{0,t} of the first input, respectively).

The adder 12 and the register 13 in each of the processing elements ub_{0,0} to ub_{2,2} constitute an accumulator. In each of the processing elements ub_{0,0} to ub_{2,2}, the adder 12 adds together the multiplication result given from the multiplier 21 and the value at time t−1 (one cycle prior to the time t) that the register 13 is holding (value of the accumulator).

The register 13 holds the time t−1 multiplication result given via the adder 12, and retains the addition result output from the adder 12 at the cycle of time t.

In this manner, 3×3 processing elements are arrayed in parallel, and at time t, data w_{m,t} is input to the r processing elements Ub arranged on the m-th row and data x_{t,r} is input to the m processing elements arranged on the r-th column. Accordingly, at the time t, the processing element at the m-th row and the r-th column performs the calculation expressed as:

y_{m,r,t}=y_{m,r,t-1}+w_{m,t}×x_{t,r} (4)

in which y_{m,r,t} represents the value newly stored at the time t in the register 13 in the processing element ub_{m,r}. Consequently, the arithmetic operations according to the expression (1) are finished by T cycles. That is, the determinant Y=W×X can be calculated by the 3×3 processing elements each calculating y_{m,r} over the T cycles.

The time t value in the register 13 in each processing element ub_{m,r} is output to the post-processing circuitry 3. The processing elements ub_{0,0} to ub_{2,2} may be configured as follows.

In each processing element ub_{m,r} within the product-sum operation circuitry 1a, the multiplier 21 as an AND logic gate receives two 1-bit inputs, namely, 1-bit data w_{m,t} and 1-bit data x_{t,r}. The multiplier 21 provides a 1-bit output, namely, an AND logic value based on the data w_{m,t} and x_{t,r}.

The adder 12 receives a 1-bit input, which is the 1-bit output data from the multiplier 21. The other input to the adder 12 consists of multiple bits from the register 13. That is, a time t−1 multibit value in the register 13 is input to the adder 12. The adder 12 provides multibit output data that corresponds to a sum of the 1-bit output data from the multiplier 21 and the time t−1 multibit value in the register 13.

The register 13 receives a multibit input. That is, the register 13 retains the multibit output data from the adder 12, which has been obtained at the adder 12 by addition of the 1-bit output data given from the multiplier 21 at time t. The values at time T (cycles) in the respective registers 13 in the processing elements ub_{m,r} of the product-sum operation circuitry 1a are output to the post-processing circuitry 3.

The output from each processing element ub_{m,r} in the product-sum operation circuitry 1a is supplied to the post-processing circuitry 3.

Note that the multiplier 21 have been adopted on the assumption that the 1-bit data items w_{m,t} and x_{t,r} are expressed as “(1,0)”, as the AND logic gate. If the data items w_{m,t} and x_{t,r} are expressed as “(+1, −1)”, the multiplier 21 are replaced by XNOR logic gates.

Also, each processing element ub_{m,r} may include the AND logic gate, an XNOR logic gate (not shown), and a selection circuit (not shown) that is adapted to select the AND logic gate or the XNOR logic gate according to the setting of the register.

Moreover, while the accumulator of a 1-bit input type may be constituted by the adder 12 and the register 13 as shown in FIG. 9, an asynchronous counter may also be used.

As shown in FIG. 9, in the product-sum operation circuitry 1a where the 3-bit data w_{0,t} and x_{t,0} are input, the value at the 0th bit (LSB) of the data w_{0,t} is input to a data line for the data w_{0,t}⁽⁰⁾, the value at the 1st bit of the data w_{0,t} is input to a data line for the data w_{0,t}⁽¹⁾, and the value at the 2nd bit (MSB) of the data w_{0,t} is input to a data line for the data w_{0,t}⁽²⁾.

Also, the value at the 0th bit (LSB) of the data x_{t,0} is input to a data line for the data x_{t,0}⁽⁰⁾, the value at the 1st bit of the data x_{t,0} is input to a data line for the data x_{t,0}⁽¹⁾, and the value at the 2nd bit (MSB) of the data x_{t,0} is input to a data line for the data x_{t,0}⁽²⁾.

For example, if the data w_{0,t} is 3-bit data expressed as “011_{b}” at time t, “1” is input to the data line for the data) w_{0,t}⁽⁰⁾, “1” is input to the data line for the data ww_{0,t}⁽¹⁾, and “0” is input to the data line for the data w_{0,t}⁽²⁾.

Also, if the data x_{t,0} is 3-bit data expressed as “110_{b}” at the time t, “0” is input to the data line for the data x_{t,0}⁽⁰⁾, “1” is input to the data line for the data x_{t,0}⁽¹⁾, and “1” is input to the data line for the data w_{t,0}⁽²⁾.

That is, when the data w_{m,t} and x_{t,r} are each 3-bit data, they may be expressed as below. Here, however, the description will focus only on one element of the output, and will omit the indices m and r as used in the foregoing descriptions. The values of wₜ⁽²⁾, etc., are all 1-bit values (0 or 1).

wₜ=wₜ⁽²⁾×2²+wₜ⁽¹⁾×2¹+wₜ⁽⁰⁾×2⁰ (5)

xₜ=xₜ⁽²⁾×2²+xₜ⁽¹⁾×2¹+xₜ⁽⁰⁾×2⁰ (6)

In this instance, the expression (3) becomes the following.

$$y = {\sum }_{t = 0}^{T - 1} {w}_{t} \times {x}_{t} = {\sum }_{c = 0}^{T - 1} j ( {w}_{t}^{( 2 )} \times {2}^{2} + {w}_{t}^{( 1 )} \times {2}^{1} + {w}_{t}^{( 0 )} \times {2}^{0} ) \times ( {x}_{t}^{( 2 )} \times {2}^{2} + {x}_{t}^{( 1 )} \times {2}^{1} + {x}_{t}^{( 0 )} \times {2}^{0} ) j = \{ {\sum }_{t = 0}^{T - 1} {w}_{t}^{( 2 )} {x}_{t}^{( 2 )} \} \times {2}^{4} + \{ {\sum }_{t = 0}^{T - 1} {w}_{t}^{( 2 )} {x}_{t}^{( 1 )} \} \times {2}^{3} + \{ {\sum }_{t = 0}^{T - 1} {w}_{t}^{( 2 )} {x}_{t}^{( 0 )} \} \times {2}^{2} + \{ {\sum }_{t = 0}^{T - 1} {w}_{t}^{( 1 )} {x}_{t}^{( 2 )} \} \times {2}^{3} + \{ {\sum }_{t = 0}^{T - 1} {w}_{t}^{( 1 )} {x}_{t}^{( 1 )} \} \times {2}^{2} + \{ {\sum }_{t = 0}^{T - 1} {w}_{t}^{( 1 )} {x}_{t}^{( 0 )} \} \times {2}^{1} + \{ {\sum }_{t = 0}^{T - 1} {w}_{t}^{( 0 )} {x}_{t}^{( 2 )} \} \times {2}^{2} + \{ {\sum }_{t = 0}^{T - 1} {w}_{t}^{( 0 )} {x}_{t}^{( 1 )} \} \times {2}^{1} + \{ {\sum }_{t = 0}^{T - 1} {w}_{t}^{( 0 )} {x}_{t}^{( 0 )} \} \times {2}^{0} \qquad ( 7 )$$

Looking at the expression (7), the first horizontally-given three sigmas use w₍ₜ₎⁽²⁾, the second horizontally-given three sigmas use w₍ₜ₎⁽¹⁾, and the third horizontally-given three sigmas use w₍ₜ₎⁽⁰⁾. Also, the first vertically-given three sigmas use x₍ₜ₎⁽²⁾, the second vertically-given three sigmas use x₍ₜ₎⁽¹⁾, and the third vertically-given three sigmas use x₍ₜ₎⁽⁰⁾. As such, the configurations of the processing elements ub_{0,0} to ub_{2,2} shown in FIG. 9 correspond to the operations of the respective sigma terms in the expression (7).

The output of each of the processing elements ub_{0,0} to ub_{2,2} is supplied to the post-processing circuitry 3. In the post-processing circuitry 3, a final result of the multibit product-sum operation is obtained by multiplying the sigmas by their respective corresponding power-of-two coefficients and summing them. The processing of the power-of-two coefficient multiplications in the post-processing circuitry 3 may be easily performed through shift operations.

In many instances, including instances with deep neural networks, T is a relatively large value that exceeds 100. Accordingly, the processing of multiplying the 1-bit results of the product-sum operations of sigma terms by respective power-of-two coefficients and summing the sigmas in the end (that is, the post-processing) is not so frequently performed. The way in which the post-processing is performed may be discretionarily selected. For example, it may be performed in a sequential manner.

Dealing with Negatives

Assuming that the data values are handled in two's complement representation, the expressions (5) and (6) are given as the following (5′ and 6′).

wₜ=−wₜ⁽²⁾×2²+wₜ⁽¹⁾×2¹+wₜ⁽⁰⁾×2⁰ (5′)

xₜ=−xₜ⁽²⁾×2²+xₜ⁽¹⁾×2¹+xₜ⁽⁰⁾×2⁰ (6 ′)

In this instance, the expression (7) becomes the following.

$$y = {\sum }_{t = 0}^{T - 1} {w}_{t} \times {x}_{t} = {\sum }_{t = 0}^{T - 1} j ( - {w}_{t}^{( 2 )} \times {2}^{2} + {w}_{t}^{( 1 )} \times {2}^{1} + {w}_{t}^{( 0 )} \times {2}^{0} ) \times ( - {x}_{t}^{( 2 )} \times {2}^{2} + {x}_{t}^{( 1 )} \times {2}^{1} + {x}_{t}^{( 0 )} \times {2}^{0} ) j = \{ {\sum }_{t = 0}^{T - 1} {w}_{t}^{( 3 )} {x}_{t}^{( 3 )} \} \times {2}^{4} - \{ {\sum }_{t = 0}^{T - 1} {w}_{t}^{( 2 )} {x}_{t}^{( 1 )} \} \times {2}^{3} - \{ {\sum }_{t = 0}^{T - 1} {w}_{t}^{( 3 )} {x}_{t}^{( 0 )} \} \times {2}^{3} - \{ {\sum }_{t = 0}^{T - 1} {w}_{t}^{( 1 )} {x}_{t}^{( 3 )} \} \times {2}^{3} + \{ {\sum }_{t = 0}^{T - 1} {w}_{t}^{( 1 )} {x}_{t}^{( 1 )} \} \times {2}^{2} + \{ {\sum }_{t = 0}^{T - 1} {w}_{t}^{( 1 )} {x}_{t}^{( 0 )} \} \times {2}^{1} - \{ {\sum }_{t = 0}^{T - 1} {w}_{t}^{( 0 )} {x}_{t}^{( 1 )} \} \times {2}^{3} + \{ {\sum }_{t = 0}^{T - 1} {w}_{t}^{( 0 )} {x}_{t}^{( 1 )} \} \times {2}^{1} + \{ {\sum }_{t = 0}^{T - 1} {w}_{t}^{( 0 )} {x}_{t}^{( 0 )} \} \times {2}^{0} \qquad ( {7}^{′} )$$

That is, it is sufficient to change the coefficient to negative at the post-processing in the post-processing circuitry 3, and therefore, the configurations similar to FIG. 9 may be utilized.

[Second Exemplary Product-Sum Operation Circuitry (Multibit Case 2: Product-Sum Operation Circuitry When Input Data w_{m,t} Involves Different Bits and x_{t,r} is 4 Bits)]

Next, second exemplary product-sum operation circuitry will be described.

The second exemplary product-sum operation circuitry adopts a configuration of a 16×16-operator array.

The description will assume that input data X is a matrix of 32 rows and 4 columns, in which every element is expressed by 4 bits. Input data W is assumed to be a matrix of 15 rows and 32 columns, in which the bit widths of the respective rows are {1, 2, 4, 2, 2, 1, 2, 3, 2, 2, 3, 2, 1, 3, 2}; that is, in this example, the 32 elements on the 0th row are each 1 bit, the 32 elements on the 1st row are each 2 bits, the 32 elements on the 2nd row are each 4 bits, the 32 elements on the 3rd row are each 2 bits, and so on.

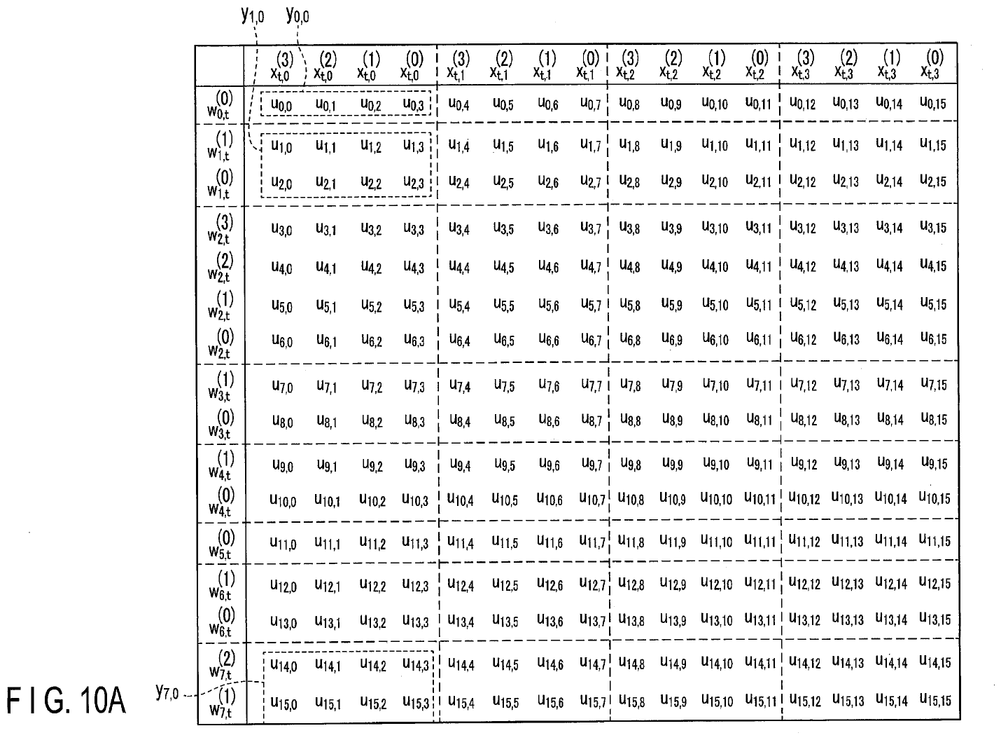

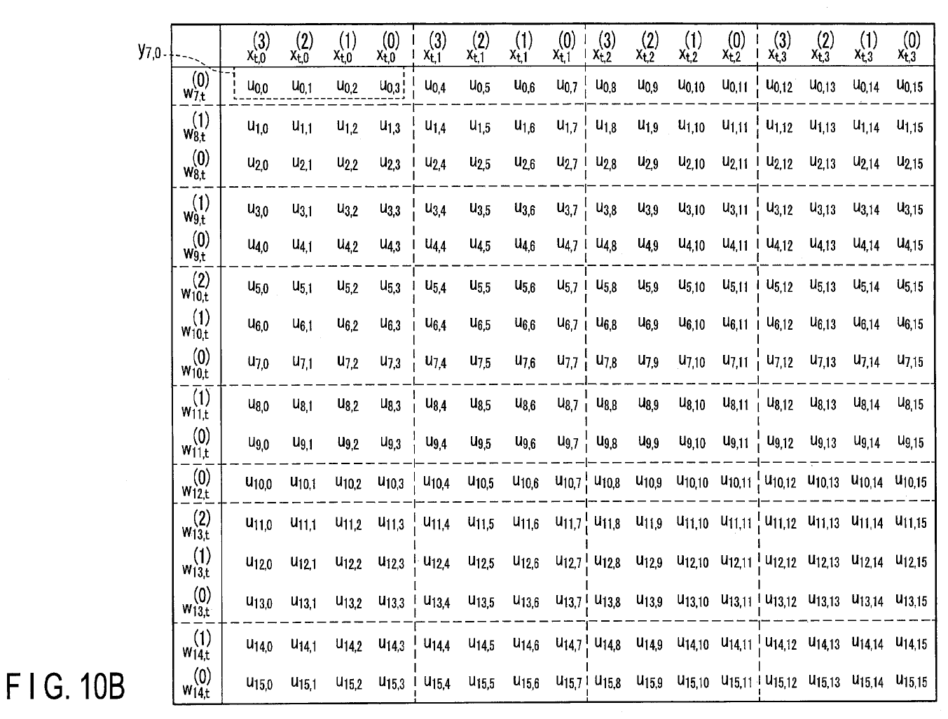

For example, referring to processing elements shown in FIGS. 10A and 10B, and assuming that the product-sum operation unit 202a according to the first embodiment is applied here, the processing elements of FIGS. 10A and 10B correspond to the case where the bit widths Bwₘ of the weights w, input to the product-sum operation unit 202a, are {1, 2, 4, 2, 2, 1, 2, 3, 2, 2, 3, 2, 1, 3, 2}, and the filters m are 0 to 14. Also, the indices n, ky, and kx are collectively handled as t (time). For example, it is possible to give t=(n×Ky+ky)×Kx+kx.

The matrix product Y=WX will be a matrix of 15 rows and 4 columns. FIGS. 10A and 10B show how the values in the input data W and X are each input to the operator array. Symbols u_{0,0} to u_{15,15} in these figures each represent one processing element. An “x_{t,r}^{(b)}” refers to the b-th bit value at the t-th row and the r-th column in the data X, and a “w_{m,t}^{(b)}” refers to the b-th bit value at the m-th row and the t-th column in the data W. Thus, t being 0 corresponds to the 0th row in X and the 0th column in W, and t being 31 corresponds to the 31st row in X and the 31st column in W.

As shown in FIG. 10A, X having 4 columns×4 bits is just accommodated in 16 columns of the processing elements, but W uses up 16 rows of the processing elements u upon the 2nd and 1st bits of its 7th row. Accordingly, calculations for the remaining rows in W, including the 0th bit of the 7th row, will be performed later.

The value of t is initially 0, and incremented by one for each cycle until it reaches 31. For example, assuming that y(u_{m,r}) is the accumulator's output from an processing element u_{m,r}, the values of y(u_{0,0}) to y(u_{0,3}) included in y_{0,0} after 32 cycles are given by the following expressions (8).

y(u_{0,0})=Σₜ₌₀³¹ w_{0,t}⁽⁰⁾x_{t,0}⁽³⁾

y(u_{0,1})=Σₜ₌₀³¹ w_{0,t}⁽⁰⁾x_{t,0}⁽²⁾

y(u_{0,2})=Σₜ₌₀³¹ w_{0,t}⁽⁰⁾x_{t,0}⁽¹⁾

y(u_{0,3})=Σₜ₌₀³¹ w_{0,t}⁽⁰⁾x_{t,0}⁽⁰⁾

By performing the following arithmetic operation on them in the post-processing circuitry 3, y_{0,0} can be obtained.

y_{0,0}=2³×y(u_{0,0})+2²×y(u_{0,1})+2¹×y(u_{0,2})+2⁰×y(u_{0,3})

Similarly, the values of y(u_{1,0}) to y(u_{2,3}) included in y_{1,0} after 32 cycles are given by the following expressions (9).

y(u_{1,0})=Σₜ₌₀³¹w_{1,t}⁽¹⁾x_{t,0}⁽³⁾

y(u_{1,1})=Σₜ₌₀³¹w_{1,t}⁽¹⁾x_{t,0}⁽²⁾

y(u_{1,2})=Σₜ₌₀³¹w_{1,t}⁽¹⁾x_{t,0}⁽¹⁾

y(u_{1,0})=Σₜ₌₀³¹w_{1,t}⁽¹⁾x_{t,0}⁽⁰⁾

y(u_{2,0})=Σₜ₌₀³¹w_{2,t}⁽⁰⁾x_{t,0}⁽³⁾

y(u_{2,1})=Σₜ₌₀³¹w_{1,t}⁽⁰⁾x_{t,0}⁽²⁾

y(u_{2,2})=Σₜ₌₀³¹w_{1,t}⁽⁰⁾x_{t,0}⁽¹⁾

y(u_{2,3})=Σₜ₌₀³¹w_{1,t}⁽⁰⁾x_{t,0}⁽⁰⁾

Using these, y_{1,0} can be calculated as follows.

y_{1,0}=2⁴×y(u_{1,0})=2³×y(u_{1,1})+2²×y(u_{1,2})+2¹×y(u_{1,3})+2³×y(u_{2,0})+2²×y(u_{2,1})+2¹×y(u_{2,2})+2⁰×y(u_{2,3}) (10)

As such, applicable values of the coefficients (powers of two), as well as correspondences (indexes) to the output elements are different for the respective results from the processing elements um,r. For example, the coefficient values and the output indexes may be set as follows.

y(u_{0,0}): coefficient=2³, output index=(0,0)

y(u_{0,1}): coefficient=2², output index=(0,0)

y(u_{0,2}): coefficient=2¹, output index=(0,0)

y(u_{0,3}): coefficient=2⁰, output index=(0,0)

y(u_{1,0}): coefficient=2⁴, output index=(1,0)

y(u_{1,1}): coefficient=2³, output index=(1,0)

y(u_{1,2}): coefficient=2², output index=(1,0)

y(u_{1,3}): coefficient=2¹, output index=(1,0)

y(u_{2,0}): coefficient=2³, output index=(1,0)

y(u_{2,1}): coefficient=2², output index=(1,0)

y(u_{2,2}): coefficient=2¹, output index=(1,0)

y(u_{2,3}): coefficient=2⁰, output index=(1,0) (11)

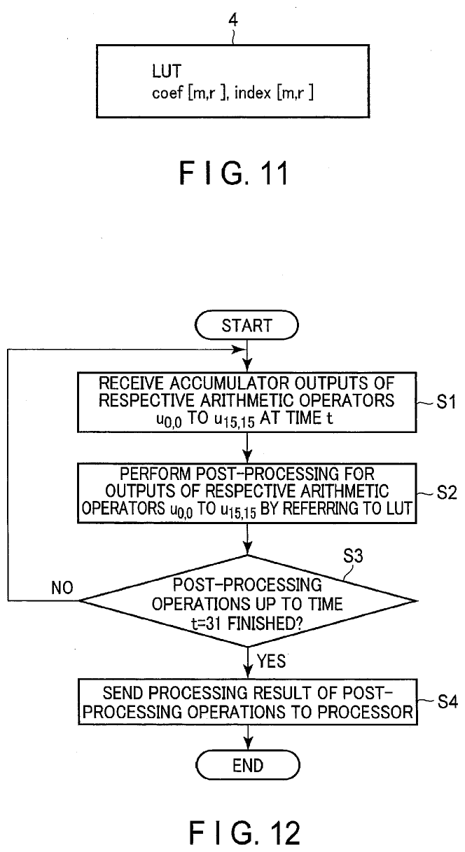

Thus, the embodiment adopts the LUT 4 that stores coefficients and output indexes addressed to “m,r”. FIG. 11 shows the LUT 4.

As shown in FIG. 11, the LUT 4 stores items, coef [m,r] and index [m,r]. The item, coef[m,r], is a coefficient to multiply the output y(u_{m,r}) of the processing element u_{m,r} that is positioned at an m-th row and an r-th column. The item, index[m,r], is an output index to put to the output y(u_{m,r}) of the processing element u_{m,r}.

Turning back to FIG. 10A, one operation by one set of the processing elements u can only cover the calculations up to the higher two bits of the three bits in w_{7,t}. The coefficients and the output indexes corresponding to y(u_{14,0}) to y(u_{15,3}), which are part of the higher two bits and included in the y_{7,0}, are as follows.

y(u_{14,0}): coefficient=2⁵, output index=(7,0)

y(u_{14,1}): coefficient=2⁴, output index=(7,0)

y(u_{14,2}): coefficient=2³, output index=(7,0)

y(u_{14,3}): coefficient=2², output index=(7,0)

y(u_{15,0}): coefficient=2⁴, output index=(7,0)

y(u_{15,1}): coefficient=2³, output index=(7,0)

y(u_{15,2}): coefficient=2², output index=(7,0)

y(u_{15,3}): coefficient=2¹, output index=(7,0) (12)

Therefore, y_{7,0} has a value given by the following.

y_{7.0}=2⁵×y(u_{14,0})+2⁴×y(u_{14,1})+2³×y(u_{14,2})+2²+y(u_{14,3})+2⁴×y(u_{15.0})+2³×y(u_{15.1})+2²×y(u_{15,2})+2¹×y(u_{15,3}) (13)

The remaining 1 bit is handled after the completion of the operation shown in FIG. 10A, and now the data w shown in FIG. 10B is input to the processing elements u_{0,0} to u_{15,15}. In this example, x is the same as x in FIG. 10A. The coefficients and the output indexes corresponding to y(u_{0,0}) to y(u_{0,3}), namely, the remaining lower 1 bit of y_{7,0}, are as follows.

y(u_{0,0}): coefficient=2³, output index=(7,0)

y(u_{0,1}): coefficient=2², output index=(7,0)

y(u_{0,2}): coefficient=2¹, output index=(7,0)

y(u_{0,3}): coefficient=2⁰, output index=(7,0)

The post-processing with these values, according to the algorithm based on the coefficients and the output indexes, will give the following expression (14) incorporating the expression (13).

y_{7,0}=2⁵×y(u_{14,0})+2⁴×y(u_{14,1})+2³×y(u_{14,2})+2²×y(u_{14.3})+2⁴+y(u_{15,0})+2³×y(u_{15,1})+2²×y(u_{15,2})+2¹×y(u_{15,3})+2³×y(u_{0,0})+2²×y(u_{0,1})+2¹×y(u_{0,2})+2⁰×y(u_{0,3}) (14)

This completes the calculation for y_{7,0}, which was incomplete at the processing shown in FIG. 10A.

FIG. 12 is a flowchart for explaining the post-processing operation for the second exemplary product-sum operation circuitry.

As shown in FIG. 12, the post-processing circuitry 3 receives an output at time t (t=0 at the start) of the accumulator in each processing element u_{m,r} (step S1). The post-processing circuitry 3 performs the post-processing of multiplying the output y(u_{m,r}) of each processing element u_{m,r} by the corresponding coefficient stored in the LUT 4 and putting the output index to it (step S2).

It is then determined whether or not all the post-processing operations for the accumulator outputs from the processing elements u_{0,0} to u_{15,15}, up to time t=31, have been finished (step S3). If it is determined that all the post-processing operations have not yet been finished (NO in step S3), the post-processing circuitry 3 returns to step S1, and performs the remaining post-processing operations for the accumulator outputs from the processing elements u_{0,0} to u_{15,15}, for the time t=1 and onward.

On the other hand, if it is determined in step S3 that all the post-processing operations for the accumulator outputs from the processing elements u_{0,0} to u_{15,15} up to time t=31 have been finished (YES in step S3), the post-processing circuitry 3 sends the result of the post-processing operations to the processor 5 (step S4), and terminates the processing.

### [Effects]

With the configuration of the product-sum operation circuitry 1 for the information processing apparatus 100 according to the embodiments, it is possible to reduce the data transfers from the memory, such as an SRAM, to the operator array of the product-sum operation circuitry 1. Consequently, the data processing by the information processing apparatus 100 can be realized with an improved efficiency.

When M×R processing elements are arrayed in parallel, the total number of times of the product-sum operations is M×R×T. Supposing that the apparatus has one processing element, then 2×M×R×T data transfers are required in total, since two data items need to be transferred from the memory to the processing element each time the product-sum operation is performed. In the configuration according to the embodiment shown in FIG. 9, the data lines for data w_{m,t} and x_{t,r} are arranged to be common to the processing elements ub_{0,0} to ub_{M-1,R-1} for each row and column; therefore, the number of data transfers is given as (M+R)×T. For example, if M=R, the number of data transfers in the embodiment is given as {(M+R)×T}/(2×M×R×T)=1/M, in contrast to the cases where the configuration of FIG. 9 is not adopted.

With the information processing apparatus 100 according to the embodiments in the first and second exemplary multibit cases, suitable coefficients and output indexes are set in the LUT 4 in accordance with the bit widths of the input data X and W, and the post-processing algorithms are applied as discussed above. Thus, the data X and W can be processed even when they are of various bit numbers differing from each other.

Also, the embodiments can duly deal with the instances where one value must be segmented, as the value y₇ in the second exemplary case. The embodiments as such can make full use of the operator array without idle resources, and this contributes to the improved efficiency and the accelerated processing speed of the processing elements.

For example, a semiconductor device that adopts parallel operations of multiple 1-bit processing elements is not capable of coping with the demand for an accuracy level of 2 or more bits. In contrast, the 1 bit×1 bit product-sum operations in the first and second exemplary cases of the embodiments enable comparably high-speed processing while being capable of coping with multibit inputs.

The embodiments further contrast with multibit×multibit-dedicated circuitry (e.g., GPU). Note that when processing elements are each adapted for multibit×multibit operations, the circuit size of one processing element is larger than a processing element for 1 bit×1 bit operations.

Provided that the same parallel number and the same processing time for one operation of processing elements are set, the product-sum operation circuitry in the first and second exemplary cases of the embodiments has a smaller circuit size for performing 1 bit×1 bit product-sum operations while having the same processing speed.

In other words, using multibit×multibit-dedicated processing elements for performing 1 bit×1 bit operations involves idle circuits. This means that resources are largely wasted and efficiency is sacrificed.

For example, when there are 16×16 processing elements, 16×16=256 parallel operations can be performed as 1 bit×1 bit product-sum operations. Using the same configuration, (16/4)×(16/4)=16 parallel operations can be performed as 4 bits×4 bits product-sum operations. Also, the two matrices do not need to have the same bit widths, and it is possible to perform, for example, (16/2)×(16/8)=16 parallel operations as 2 bits×8 bits product-sum operations.

The first and second exemplary cases of the embodiments eliminate the idle resources as noted above by efficiently allowing all the processing elements to be used irrespective of the bit widths of input data. In the instances of multibit×multibit product-sum operations, still, the embodiments require multiple processing elements to deal with a calculation that is performed by one multibit×multibit-dedicated processing element. As such, on the condition that the same parallel number is set, the product-sum operation circuitry in the first and second exemplary cases of the embodiments—which may be hypothesized to have a smaller parallel number on an equivalent basis—operates at a relatively low processing speed as compared to the circuitry of multibit x multibit-dedicated processing elements.

However, the embodiments can have a smaller circuit size for one processing element as compared to a multibit×multibit-dedicated processing element. Accordingly, the embodiments can have a larger parallel number for processing elements when the size of the entire circuitry is the same.

Ultimately, the embodiments provide a higher processing speed when the bit widths of input data are small, while providing a lower processing speed when the bit widths of input data are large Despite this, in most instances (for example, in the processing for deep learning where the desired bit widths of input data can vary depending on layer), small bit widths are sufficient and large bit widths are only required for a limited part. Therefore, assuming the instances where the operations using input data with small bit widths account for a larger part, the information processing apparatus 100 according to the embodiments provide a higher processing speed as a whole.

While certain embodiments have been described, they have been presented by way of example only, and they are not intended to limit the scope of the inventions. Indeed, the novel embodiments described herein may be worked in a variety of other forms. Furthermore, various omissions, substitutions, and changes in such forms of the embodiments may be made without departing from the gist of the inventions. The embodiments and their modifications are covered by the accompanying claims and their equivalents, as would fall within the scope and gist of the inventions.

What is claimed is:

1. An information processing apparatus for convolution operations in layers of a convolutional neural network, the information processing apparatus comprising:
a memory configured to store items of information indicative of an input, a weight to the input, and a bit width determined for each filter of the weight; and
a product-sum operating circuitry configured to perform a product-sum operation based on the items of information indicative of the input, the weight, and the bit width, stored in the memory.

2. The information processing apparatus according to claim 1, further comprising a bit-width calculator configured to determine the bit width based on a maximum value and a minimum value among values of the weight for each filter.

3. The information processing apparatus according to claim 1, wherein the memory is further configured to store an item of information indicative of a correction value for the bit width, and
the information processing apparatus further comprises:
a correction value calculator configured to calculate and output a correction value for the product-sum operation for each filter of the weight, based on the items of information indicative of the correction value and the input, stored in the memory; and
an adder configured to add together a result of the product-sum operation by the product-sum operating circuitry and the correction value output by the correction value calculator and output a result of adding.

4. The information processing apparatus according to claim 1, wherein the memory is further configured to store an item of information indicative of a correction value for the bit width, and
the information processing apparatus further comprises a bit-width corrector configured to obtain the items of information indicative of the weight, the bit width, and the correction value to be stored in the memory, from a weight to the input before being stored in the memory.

5. The information processing apparatus according to claim 1, wherein the product-sum operating circuitry is logical operation circuitry.

6. The information processing apparatus according to claim 1, wherein the product-sum operating circuitry is a processor.

7. An information processing apparatus for convolution operations in layers of a convolutional neural network, the information processing apparatus comprising:
a memory configured to store items of information indicative of an input, a plurality of weights to the input, and a plurality of bit widths which are determined for multiple filters of the weights, respectively; and
a product-sum operating circuitry configured to perform a product-sum operation for the multiple filters, based on the items of information indicative of the input, the weights, and the bit widths, stored in the memory.

8. The information processing apparatus according to claim 7, wherein the memory is further configured to store items of information indicative of a plurality of correction values for the bit widths,
the information processing apparatus further comprises:
a correction value calculator configured to output a correction value for the product-sum operation, based on the items of information indicative of the correction values and the input, stored in the memory; and
an adder configured to add together a result of the product-sum operation by the product-sum operating circuitry and the correction value output by the correction value calculator and output a result of adding, and
the bit widths and the correction values for the multiple filters are determined for the multiple filters of the weights, respectively.

9. The information processing apparatus according to claim 7, wherein the product-sum operating circuitry is logical operation circuitry.

10. The information processing apparatus according to claim 7, wherein the product-sum operating circuitry is a processor.
